(19) United States
(12) Patent Application Publication
(10) Pub. No.: US 2014/0180938 A1
(43) Pub. Date: Jun. 26, 2014

(54) LICENSE APPLICATION PROCESSOR FOR TELECOMMUNICATIONS EQUIPMENT

(71) Applicant: VERIZON PATENT AND LICENSING INC., Basking Ridge, NJ (US)

(72) Inventors: Harold R. DOMKE, Freehold, NJ (US); Prakash KADHATI, Chittoor (IN); Subbarao ALLURI, Hyderabad (IN); Bhupesh Kumar TAMINAINA, Hyderabad (IN); Ramesh BALASEKARAN, Chennai (IN); Seenuvasan ARUMUGAM, Thiruvannamalai (IN); Vetha S.A. MANICKAM, Chennai (IN); Nageswara R. TANUKU, Nanuet, NY (US); Claire A. COONEY, Freehold Township, NJ (US)

(73) Assignee: Verizon Patent and Licensing Inc., Basking Ridge, NJ (US)

(21) Appl. No.: 13/727,247

(22) Filed: Dec. 26, 2012

(51) Int. Cl. G06Q 30/00

(52) U.S. Cl. CPC G06Q 30/018
USPC 705/317

(57) ABSTRACT

A device is configured to receive application information associated with an application for a license to use field equipment associated with a potential licensor. The application information may identify a potential licensee, the field equipment, and a requested usage of the field equipment. The device is configured to determine, based on the application information and the identified field equipment, that a virtual field survey is to be conducted, to receive information that identifies an available usage of the field equipment, to determine that the available usage satisfies the requested usage, and to transmit a notification to a licensee device associated with the potential licensee or a licensor device associated with the potential licensor.

### BACKGROUND

A telecommunications company may license the use of telecommunications equipment owned by the company. For example, various laws may impose requirements and regulations for sharing the use of telecommunications equipment, such as telephone poles, man holes, cellular towers, buildings, and communications conduits, with third parties. These requirements and regulations set forth mandatory processes, procedures, deadlines, terms, and conditions that govern the application process required for a third party to license the use of telecommunications equipment from a telecommunications provider.

### BRIEF DESCRIPTION OF THE DRAWINGS

FIGS. 1A and 1B are diagrams of an overview of an example implementation described herein;

FIG. 2 is a diagram of an example environment in which systems and/or methods described herein may be implemented;

FIG. 3 is a diagram of example components of one or more devices of FIG. 2;

FIG. 4 is a flow chart of an example process for managing workflow steps associated with processing an application to license the use of field equipment;

FIGS. 5A-5C are diagrams of an example implementation relating to the example process shown in FIG. 4;

FIGS. 6A-6I are flow charts of example workflow steps that may be managed according to the example process shown in FIG. 4; and

FIGS. 7A and 7B are diagrams of an example implementation relating to the example process shown in FIG. 4, and the example workflow steps shown in FIGS. 6A-6I.

### DETAILED DESCRIPTION OF PREFERRED EMBODIMENTS

The following detailed description of example implementations refers to the accompanying drawings. The same reference numbers in different drawings may identify the same or similar elements.

A telecommunications company may license the use of telecommunications equipment owned by the company. For example, in the United States, various state and federal laws (e.g., The Telecommunications Act) impose requirements and regulations for sharing the use of telecommunications equipment, such as telephone poles, man holes, cellular towers, buildings, and communications conduits, with third parties. These requirements and regulations set forth mandatory processes, procedures, deadlines, terms, and conditions, regulated by the Federal Communications Commission (FCC), that govern the application process required for a third party to license the use of telecommunications equipment from a telecommunications provider.

A telecommunications company may have difficulty complying with the requirements and regulations for licensing telecommunications equipment for several reasons. First, the number of applications for equipment licenses is rapidly increasing, making it difficult to process the license applications in a timely manner (e.g., according to FCC deadlines). Second, the license application process has not been standardized, which may lead to confusion, rework, and delays in application processing. Implementations described herein may streamline and standardize the license application process by utilizing a workflow management system, thus decreasing delays associated with application processing, and assisting telecommunications companies in meeting mandatory deadlines.

As used herein, a licensor may refer to a telecommunications company that provides a license, to a third party, to use telecommunications equipment. The term “licensor” may be used interchangeably with the term “potential licensor” (e.g., when the application is being processed and has not yet been approved). As used herein, a licensee may refer to a third party that obtains a license, from a telecommunications company, for the use of telecommunications equipment. The term “licensee” may be used interchangeably with the term “potential licensee” (e.g., when the application is being processed and has not yet been approved). Telecommunications equipment (also referred to herein as field equipment) may refer to any equipment associated with providing telecommunications services, such as telephone poles, communications conduits (e.g., pipes that house fiber optic cables), base stations, man holes, antennas, etc.

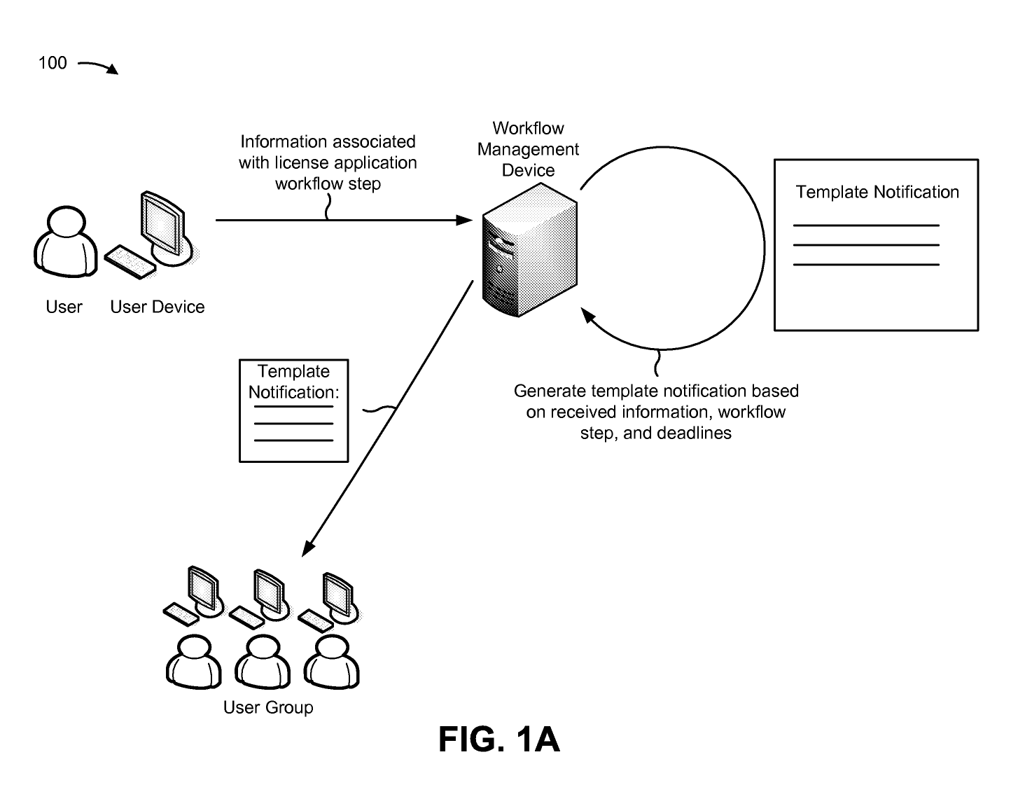

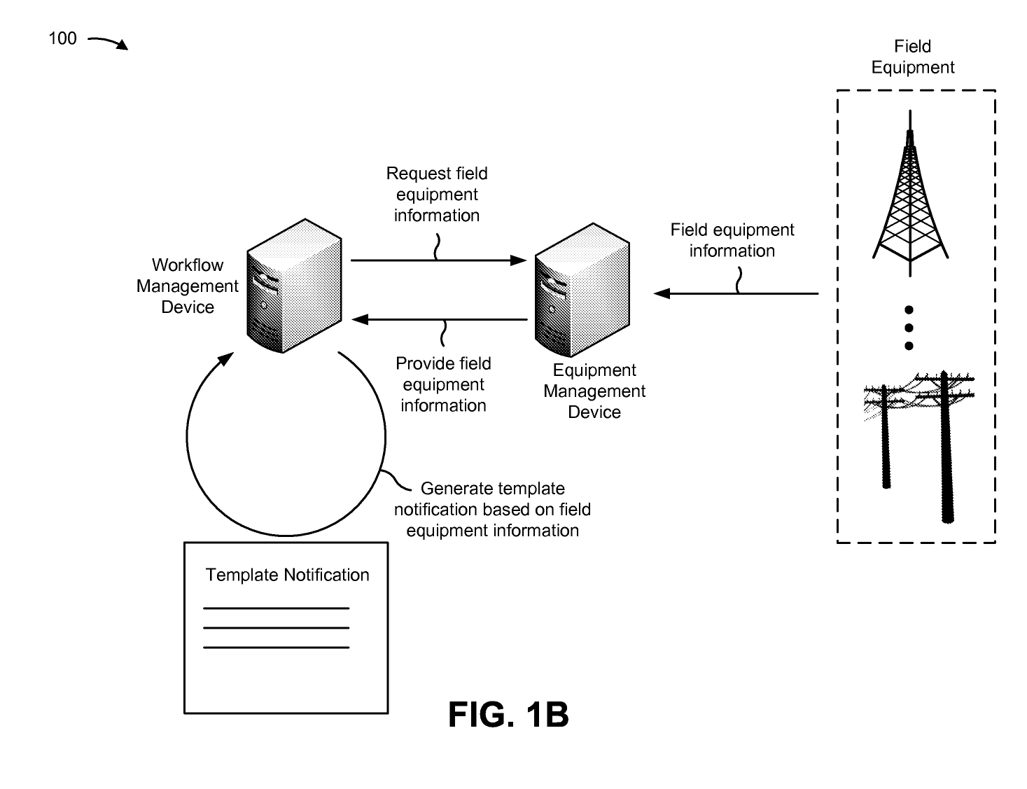

FIGS. 1A and 1B are diagrams of an overview of an example implementation 100 described herein. As shown in FIG. 1A, implementation 100 may include one or more user devices associated with a user and/or a user group, and a workflow management device. For example, the user devices may include, for example, desktop computers, tablet computers, smart phones, or handheld devices, and the workflow management device may include a server.

As further shown in FIG. 1A, a user interacting with the user device may input information associated with a license application workflow step. For example, the user (e.g., a licensee or potential licensee) may fill out an application to license telecommunications field equipment from a telecommunications company. The user device may transmit the information to the workflow management device. The workflow management device may receive the information, and may generate a template notification based on the information and the workflow step. In some implementations, a current workflow step may be required, by the FCC, to be completed within a certain period of time. For example, the telecommunications company may be required to respond to the license application within five days.

The template notification, generated by the workflow management device, may include information relevant to the current workflow step. For example, the template notification may identify the current workflow step, a next workflow step to be completed after the current workflow step, information required to complete the current workflow step and/or the next workflow step, a deadline for completing the current workflow step and/or the next workflow step, a user group responsible for completing the current workflow step and/or the next workflow step, etc. The workflow management device may transmit the generated template notification to the user group (e.g., user devices associated with the user group) responsible for completing the current workflow step and/or the next workflow step. The workflow management device may determine the user group based on a user group bucket associated with the workflow step. A user may sign up for and/or be assigned to a user group bucket. The user group may include, for example, a user group associated with a telecommunications company, such as an engineering group, a construction group, a license administration group, etc.

As shown in FIG. 1B, a workflow step may require the workflow management device to gather additional information to generate the template notification. For example, a workflow step may require the workflow management device to determine information associated with field equipment, such as whether the field equipment is available for licensing and/or has the capacity to support the usage requested in a licensing application. Field equipment may include, for example, poles (e.g., telephone poles), conduits (e.g., that house wires, cables, etc.), etc.

As further shown in FIG. 1B, the workflow management device may request field equipment information from an equipment management device, which may include a server. The equipment management device may store and/or have access to information associated with field equipment, such as information that identifies field equipment availability, field equipment capacity, field equipment utilization, images of a field equipment site, etc. The equipment management device may, in some implementations, communicate with the field equipment to determine the field equipment information (e.g., may communicate with a base station, an antenna, etc.).

The equipment management device may respond to the request from the workflow management device by providing the field equipment information. The workflow management device may generate the template notification based on the field equipment information. The workflow management device may transmit the generated template notification to the user group (e.g., user devices associated with the user group) responsible for completing a workflow step (e.g., users included in a user group bucket associated with the workflow step), as discussed above in connection with FIG. 1A. The workflow management device may continue to associate the license application with the user group until the user group completes the workflow step.

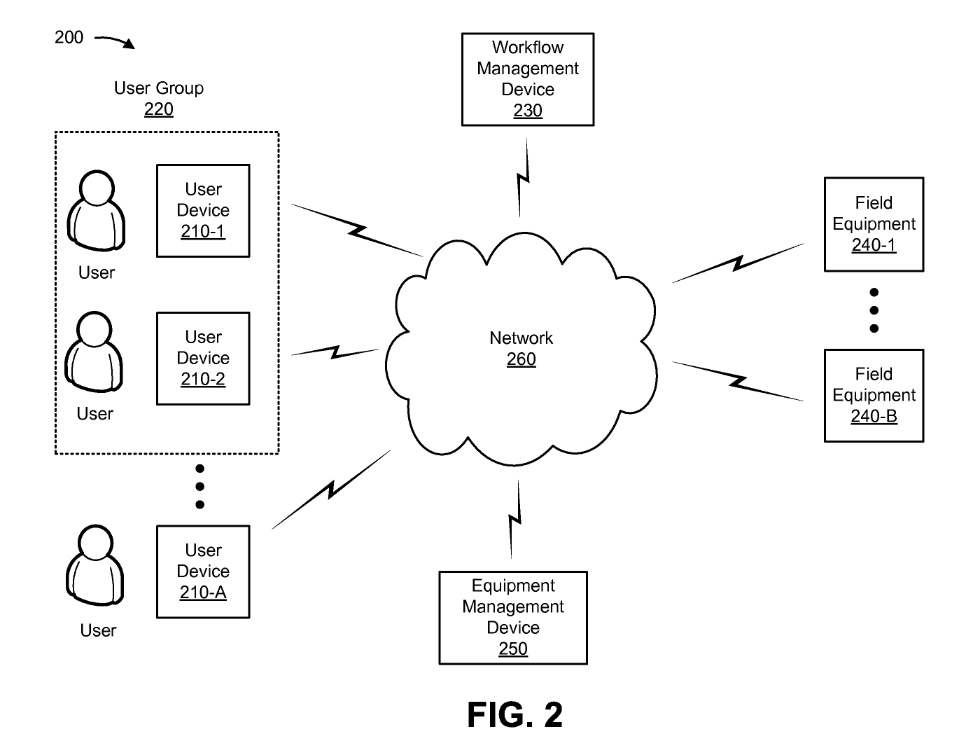

FIG. 2 is a diagram of an example environment 200 in which systems and/or methods described herein may be implemented. As shown in FIG. 2, environment 200 may include one or more user devices 210-1 through 210-A (A≧1) (hereinafter referred to collectively as “user devices 210,” and individually as “user device 210”) associated with one or more users and/or user groups 220, a workflow management device 230, field equipment 240-1 through 240-B (B≧1) (hereinafter referred to individually or collectively as “field equipment 240”), equipment management device 250, and network 260. The devices of environment 200 may interconnect (e.g., via network 260) via wired connections, wireless connections, or a combination of wired and wireless connections.

User device 210 may include a device capable of accessing network 260, such as a computing and communications device. For example, user device 210 may include a desktop computer, a laptop computer, a tablet computer, a handheld computer, a smart phone, a radiotelephone, or a similar device. In some implementations, user device 210 may transmit information to and/or receive information from workflow management device 230. In some implementations, user device 210 may include a licensee device associated with a licensee (e.g., associated with a licensee user group 220). Additionally, or alternatively, user device 210 may includes a licensor device associated with a licensor (e.g., associated with a licensor user group 220).

User group 220 may include one or more users associated with one or more user devices 210. User group 220 may include a single user associated with a single user device 210, a single user associated with multiple user devices 210, multiple users associated with a single user device 210, and/or multiple users associated with multiple user devices 210 (e.g., each user being associated with one or more user devices 210). As used herein, user group 220 may refer to the users in user group 220 and/or the user devices 210 associated with the users in user group 220. In some implementations, user group 220 may receive information from workflow management device 230. In some implementations, user group 220 may include a group of users assigned to a user group bucket. A user group 220 may be associated with a particular workflow step, and may receive template notifications from workflow management device 230 regarding the workflow step. User group 220 may include a licensee group, a licensor group, a license application processing group, an engineering group, a field surveyor group, a construction group, etc. In some implementations, user group 220 may include one or more users associated with the FCC.

Workflow management device 230 may include a server, or another type of computation and communication device (e.g., a desktop computer, a laptop computer, etc.). Workflow management device 230 may receive information associated with a workflow step from user device 210 and/or equipment management device 250, and may generate one or more template notifications based on the information. Workflow management device 230 may transmit the one or more template notifications to one or more user groups 220 associated with a workflow step.

Field equipment 240 may include equipment associated with providing telecommunications services. For example, field equipment 240 may include a pole (e.g., a telephone pole, a utility pole, etc.), a conduit and/or a pipe (e.g., that houses copper wires and/or fiber optic cables), a man hole, a building, a cable (e.g., a copper and/or fiber optic cable), a utility box, a service drop, a base station (e.g., a cell tower, an antenna, etc.), etc. Some field equipment 240 (e.g., a utility box, a base station, an antenna, etc.) may be capable of communicating with equipment management device 250. Other field equipment 240 (e.g., a pipe, a conduit, etc.) may not be capable of communicating with equipment management device 250.

Equipment management device 250 may include a server, or another type of computation and communication device (e.g., a desktop computer, a laptop computer, etc.). Equipment management device 250 may receive information associated with field equipment 240, such as information that identifies field equipment availability, field equipment capacity, field equipment utilization, images of a field equipment site, etc. In some implementations, equipment management device 250 may communicate with field equipment 240 to receive the information. Additionally, or alternatively, the information may be input to equipment management device 250 by a user and/or another device.

Network 260 may include one or more wired and/or wireless networks. For example, network 260 may include a cellular network, a public land mobile network (“PLMN”), a second generation (“2G”) network, a third generation (“3G”) network, a fourth generation (“4G”) network, a fifth generation (“5G”) network, a long term evolution (“LTE”) network, and/or another network. Additionally, or alternatively, network 260 may include a local area network (“LAN”), a wide area network (“WAN”), a metropolitan area network (“MAN”), a telephone network (e.g., the Public Switched Telephone Network (“PSTN”)), an ad hoc network, an intranet, the Internet, a fiber optic-based network, and/or a combination of these or other types of networks.

The number of devices/networks shown in FIG. 2 is provided for explanatory purposes. In practice, environment 200 may include additional devices/networks, fewer devices/networks, different devices/networks, or differently arranged devices/networks. Furthermore, two or more devices shown in FIG. 2 may be implemented within a single device, or a single device shown in FIG. 2 may be implemented as multiple, distributed devices. Additionally, one or more of the devices of environment 200 may perform one or more functions described as being performed by another one or more devices of environment 200.

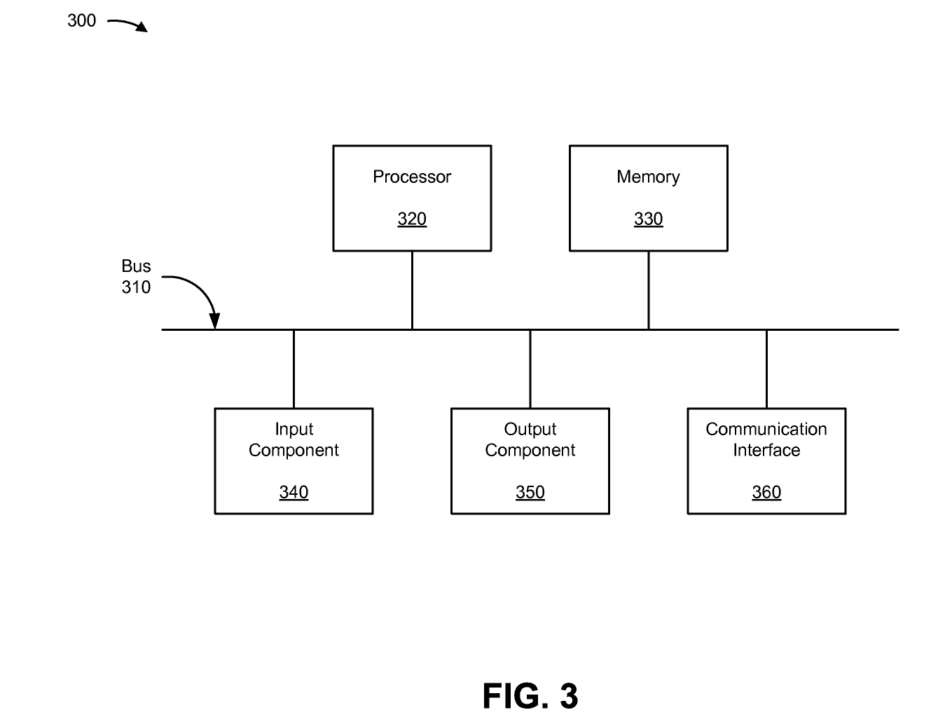

FIG. 3 is a diagram of example components of a device 300. Device 300 may correspond to user device 210, workflow management device 230, field equipment 240, and/or equipment management device 250. As shown in FIG. 3, device 300 may include a bus 310, a processor 320, a memory 330, an input component 340, an output component 350, and a communication interface 360.

Bus 310 may include a path that permits communication among the components of device 300. Processor 320 may include a processor (e.g., a central processing unit, a graphics processing unit, an accelerated processing unit), a microprocessor, and/or any processing logic (e.g., a field-programmable gate array (“FPGA”), an application-specific integrated circuit (“ASIC”), etc.) that interprets and/or executes instructions. Memory 330 may include a random access memory (“RAM”), a read only memory (“ROM”), and/or another type of dynamic or static storage device (e.g., a flash, magnetic, or optical memory) that stores information and/or instructions for use by processor 320.

Input component 340 may include a component that permits a user to input information to device 300 (e.g., a touch screen display, a keyboard, a keypad, a mouse, a button, a switch, etc.). Output component 350 may include a component that outputs information from device 300 (e.g., a display, a speaker, one or more light-emitting diodes (“LEDs”), etc.).

Communication interface 360 may include a transceiver-like component, such as a transceiver and/or a separate receiver and transmitter, that enables device 300 to communicate with other devices, such as via a wired connection, a wireless connection, or a combination of wired and wireless connections. For example, communication interface 360 may include an Ethernet interface, an optical interface, a coaxial interface, an infrared interface, a radio frequency (“RF”) interface, a universal serial bus (“USB”) interface, or the like.

Device 300 may perform various operations described herein. Device 300 may perform these operations in response to processor 320 executing software instructions included in a computer-readable medium, such as memory 330. A computer-readable medium may be defined as a non-transitory memory device. A memory device may include memory space within a single storage device or memory space spread across multiple storage devices.

Software instructions may be read into memory 330 from another computer-readable medium or from another device via communication interface 360. When executed, software instructions stored in memory 330 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number of components shown in FIG. 3 is provided for explanatory purposes. In practice, device 300 may include additional components, fewer components, different components, or differently arranged components than those shown in FIG. 3. Additionally, or alternatively, each of user device 210, workflow management device 230, field equipment 240, and/or equipment management device 250 may include one or more devices 300 and/or one or more components of device 300.

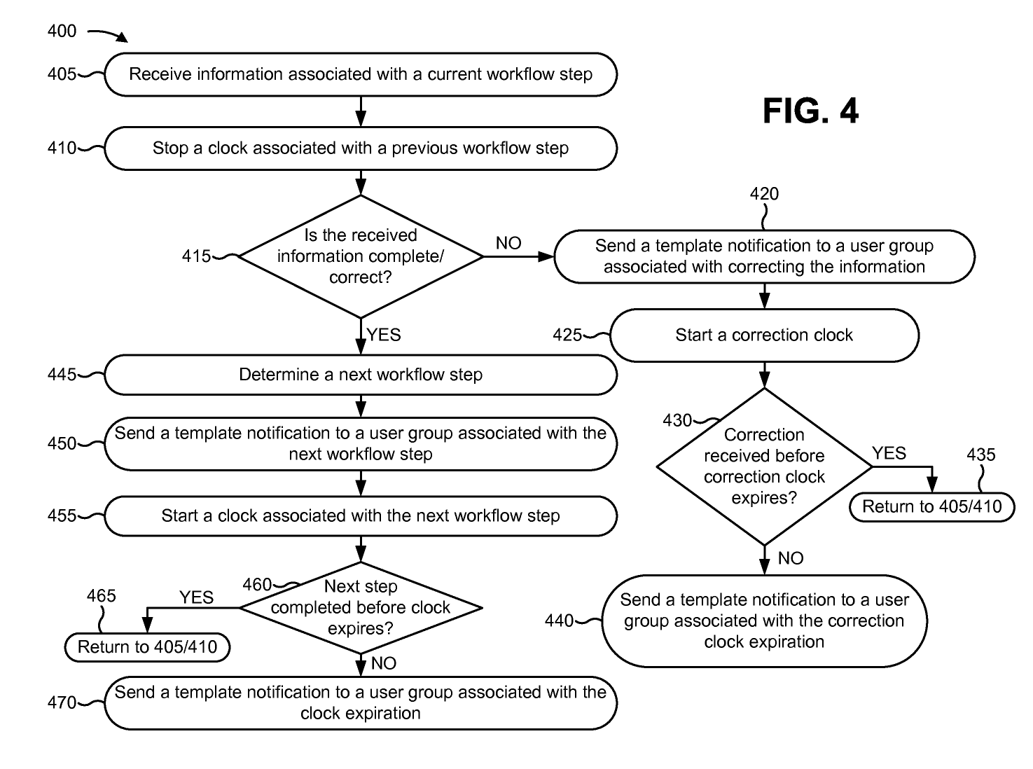

FIG. 4 is a flow chart of an example process 400 for managing workflow steps associated with processing an application to license the use of field equipment. In some implementations, one or more process blocks of FIG. 4 may be performed by workflow management device 230. Additionally, or alternatively, one or more process blocks of FIG. 4 may be performed by another device or a group of devices separate from or including workflow management device 230.

As shown in FIG. 4, process 400 may include receiving information associated with a current workflow step (block 405). For example, workflow management device 230 may receive, from user device 210, information associated with a current workflow step, such as a workflow step involved in processing an application for a license to use field equipment 240. The current workflow step may include, for example, reviewing and/or approving the license application, receiving and/or approving a payment associated with the license application, conducting a field survey of field equipment 240 (e.g., a physical field survey and/or a virtual field survey), reviewing and/or approving the field survey, making field equipment 240 ready for the use requested in the license application, issuing the license, etc. The received information may identify the current workflow step, and may include information to be used to determine and/or conduct a next workflow step (and a user group associated with the next workflow step) that follows the current workflow step (and the user group associated with the current workflow step).

In some implementations, the information may be received from user device 210 associated with a user applying for the license (e.g., a licensee). Additionally, or alternatively, the information may be received from user device 210 associated with a user and/or user group 220 responsible for determining and/or conducting a workflow step (e.g., a user group 220 associated with the licensee and/or the licensor). Additionally, or alternatively, the information may be received from a user group 220 associated with the FCC. Additionally, or alternatively, the information may be associated with field equipment 240, and may be received from equipment management device 250. For example, a workflow step may include conducting a virtual field survey, and workflow management device 230 may conduct the virtual field survey by analyzing field equipment information received from equipment management device 250.

As shown in FIG. 4, process 400 may include stopping a clock associated with a previous workflow step (block 410). For example, workflow management device 230 may receive information associated with a current workflow step, and may stop a clock associated with a previous workflow step (e.g., that precedes the current workflow step). A workflow step may be associated with a length of time for completing the workflow step (e.g., a deadline and/or target duration specified by the FCC, the licensor, and/or the licensee). For example, a licensor may be required by the FCC to respond to an initial application for a license within fifteen (15) days, and/or may be required to complete the application process and make field equipment 240 ready for use by the licensee within forty-five (45) days of receiving the application. In some implementations, workflow management device 230 may receive information that identifies the length of time from a device associated with the FCC, and the clocks described herein may be updated based on changes to FCC regulations. If a clock expires before a workflow step associated with the clock is completed, the license application may be cancelled, and workflow management device 230 may generate and transmit a cancellation notification to user group 220.

In some implementations, a deadline for a current workflow step may depend on a workflow step that immediately precedes the current workflow step. Additionally, or alternatively, a deadline may depend on a previous workflow step that does not immediately precede the current workflow step. In some implementations, workflow management device 230 may stop a clock that tracks a deadline that depends on an immediately preceding workflow step, and may not stop a clock that tracks a deadline that depends on a non-immediately preceding workflow step. For example, a workflow step may include multiple sub-steps. The workflow step may have a deadline, and one or more of the sub-steps may have a deadline.

As shown in FIG. 4, process 400 may include determining whether the received information is complete/correct (block 415). For example, workflow management device 230 may determine whether the received information, associated with the current workflow step, is complete and/or correct. To determine the completeness/correctness, workflow management device 230 may determine whether there is any missing information (e.g., may determine whether a submitted application form has been completely filled out), may determine whether the received information includes information required to determine and/or conduct a next workflow step, etc. In some implementations, workflow management device 230 may compare the received information to required information (e.g., stored in a data structure) to determine whether the received information is complete and/or correct.

If the received information is not complete/correct (block 415—NO), then process 400 may include sending a template notification to a user group associated with correcting the information (block 420). For example, if workflow management device 230 determines that the received information is not complete and/or correct, then workflow management device 230 may send (e.g., via email), to a user group 220 responsible for correcting the received information, a template notification. The template notification may identify missing information, incomplete information, a time frame for correcting the received information, steps to be taken to correct the received information, a user and/or user group 220 responsible for correcting the received information, etc. Workflow management device 230 may generate the template notification (e.g., by generating a document and/or a file) based on the current workflow step, the received information, a user that submitted the information, a clock that is running, a deadline associated with the current workflow step, a payment amount associated with the current workflow step (e.g., a field survey or make ready process), a user group 220 responsible for correcting the information, etc. The user group 220, to which workflow management device 230 sends the template notification, may depend on the current workflow step, the missing and/or incorrect information, etc., and may include a user group 220 associated with the licensee, the licensor, and/or the FCC.

If the received information is not complete/correct (block 415—NO), then process 400 may further include starting a correction clock (block 425), and determining whether a correction is received before the correction clock expires (block 430). For example, workflow management device 230 may start a correction clock, associated with correcting the received information, and the correction clock may indicate an amount of time that has passed since workflow management device 230 sent the template notification. A workflow step that includes making a correction to incomplete/incorrect information may be associated with a length of time for correcting the incomplete/incorrect information. For example, a licensee may be required by the licensor and/or the FCC to correct the information within five (5) days.

If a correction is received before the correction clock expires (block 430—YES), then process 400 may include returning to process block 405 or 410 (block 435). For example, if workflow management device 230 receives a correction to the incomplete/incorrect information before the correction clock expires, then the received correction may be treated as the received information described in connection with process block 405, and the correction clock may be stopped, as described in connection with process block 410.

If a correction is not received before the correction clock expires (block 430—NO), then process 400 may include sending a template notification to a user group associated with the correction clock expiration (block 440). For example, if workflow management device 230 does not receive a correction to the incomplete/incorrect information before the correction clock expires, then workflow management device 230 may send, to a user group 220 associated with the correction clock expiration (e.g., associated with the licensee, the licensor, and/or the FCC), a template notification. In some implementations, the template notification may indicate that the time period for correction has expired, and may further indicate that the license application has been cancelled.

Alternatively, the template notification may indicate that a deadline for correcting the incomplete/incorrect information is approaching. For example, a deadline of ten (10) days may be set for correcting incomplete/incorrect information. After six (6) days, workflow management device 230 may send a template notification that indicates that there are four (4) days remaining to correct the incomplete/incorrect information. In this way, multiple clocks may be associated with a workflow step, or multiple template notifications may be generated as a time indicated by a clock passes. The information identified in each of the multiple template notifications may be the same or different.

If the received information is complete/correct (block 415—YES), then process 400 may include determining a next workflow step (block 445), and sending a template notification to a user group associated with the next workflow step (block 450). For example, if workflow management device 230 determines that the received information is complete and correct, then workflow management device 230 may determine a next workflow step. In some implementations, workflow management device 230 may access a data structure that lists a series of workflow steps and/or conditions for proceeding to a next workflow step. Workflow management device 230 may determine the next workflow step based on the current workflow step, the received information, and/or the stored conditions.

Workflow management device 230 may send a template notification to user group 220 associated with the next workflow step. For example, workflow management device 230 may generate the template notification based on the current and/or next workflow step, the received information, the user that submitted the information, a user group 220 responsible for conducting the next workflow step, a clock and/or deadline associated with the next workflow step, a payment amount associated with the next workflow step, etc. In some implementations, workflow management device 230 may access a data structure that stores a template skeleton, and may generate the template notification based on the template skeleton and information to be added to the template skeleton. The user group 220, to which workflow management device 230 sends the template notification, may depend on the current workflow step, the next workflow step, the received information, etc., and may be associated with the licensee, the licensor, and/or the FCC.

If the received information is complete/correct (block 415—YES), then process 400 may further include starting a clock associated with the next workflow step (block 455), and determining whether the next workflow step has been completed before the clock expires (block 460). For example, workflow management device 230 may start a clock, associated with the next workflow step, that indicates an amount of time that has passed since workflow management device 230 sent the template notification. The next workflow step may be associated with a length of time for completing the next workflow step. For example, a field survey may be required to be completed within forty-five (45) days.

If the next workflow step is completed before the clock expires (block 460—YES), then process 400 may include returning to process block 405 or 410 (block 465). For example, if workflow management device 230 receives, before the clock expires, information that indicates that the next workflow step has been completed, then such information may be treated as the received information described in connection with process block 405, and the clock may be stopped, as described in connection with process block 410.

If the next workflow step is not completed before the clock expires (block 460—NO), then process 400 may include sending a template notification to a user group associated with the clock expiration (block 470). For example, if workflow management device 230 does not receive, before the clock expires, an indication that the next workflow step has been completed, then workflow management device 230 may send, to a user group 220 associated with the clock expiration, a template notification. In some implementations, the template notification may indicate that the time period for completing the next workflow step has expired, and may further indicate that the license application has been cancelled.

Alternatively, the template notification may indicate that a deadline for completing the next workflow step is approaching. For example, a deadline of thirty (30) days may be set for conducting a field survey. After twenty (20) days, workflow management device 230 may send a template notification that indicates that there are ten (10) days remaining to complete the field survey. In this way, a template notification may be sent as a clock crosses a threshold. For example, a template notification may be sent when a clock crosses 70% of the deadline, 90% of the deadline, etc.

In some implementations, workflow management device 230 may batch process the template notifications. For example, workflow management device 230 may determine, every night at midnight, clocks that have expired, and may send template notifications associated with the expired clocks. Additionally, or alternatively, workflow management device 230 may periodically generate a report that indicates a quantity of pending licenses being processed, a quantity of pending licenses in each stage (e.g., a workflow step and/or sub-step) of application processing, a user and/or user group 220 assigned to each pending license, a quantity of pending licenses assigned to a particular user and/or user group 220, an amount of time remaining on each clock, an average amount of time that a license application spends in a particular stage of processing, etc.

While a series of blocks has been described with regard to FIG. 4, the blocks and/or the order of the blocks may be modified in some implementations. For example, stopping a clock associated with a previous workflow step (block 410) may be performed after determining that the received information is complete/correct (block 415—YES). Additionally, or alternatively, non-dependent blocks may be performed in parallel.

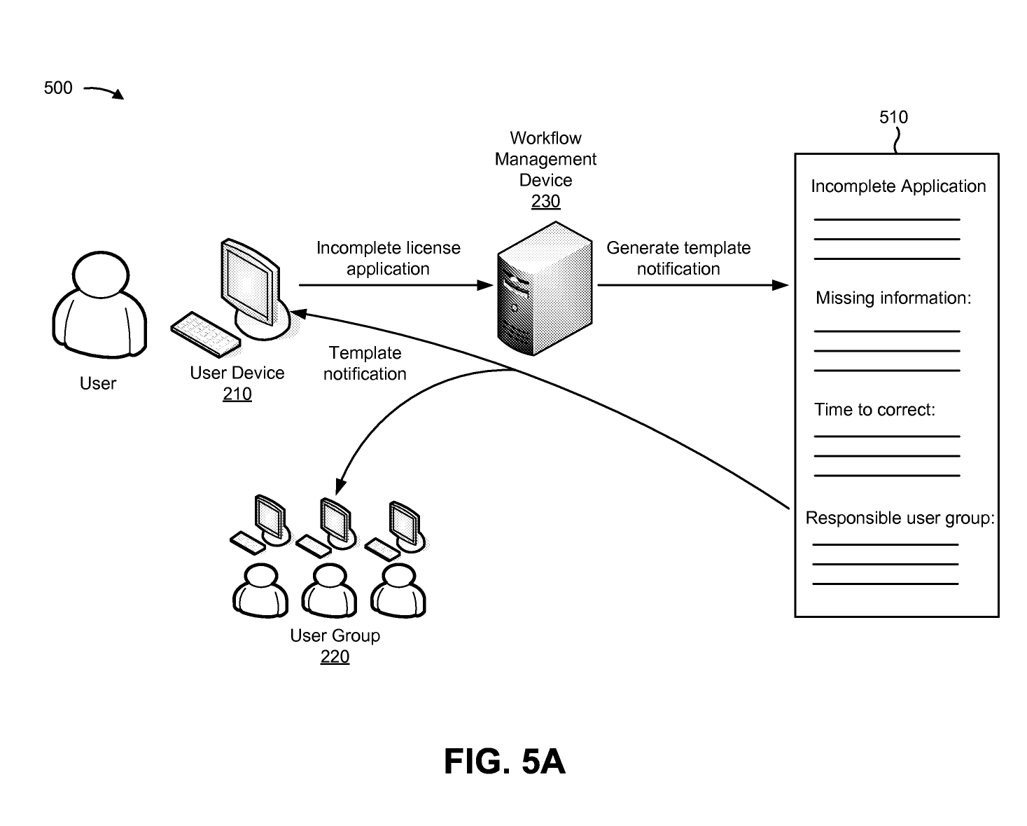

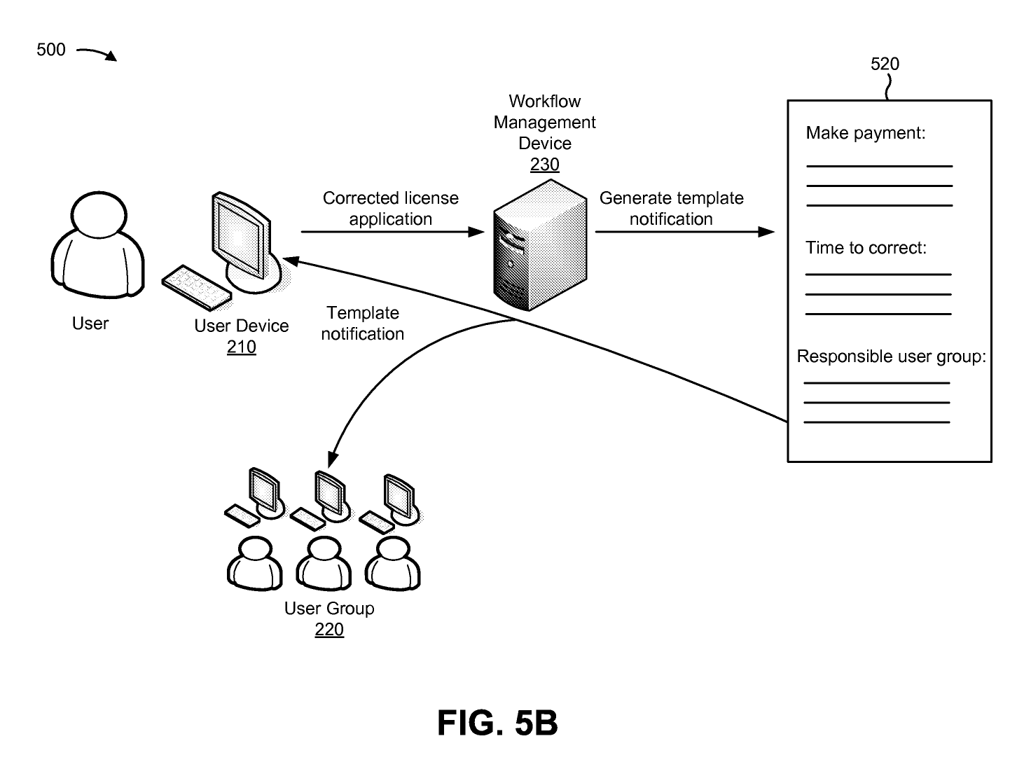

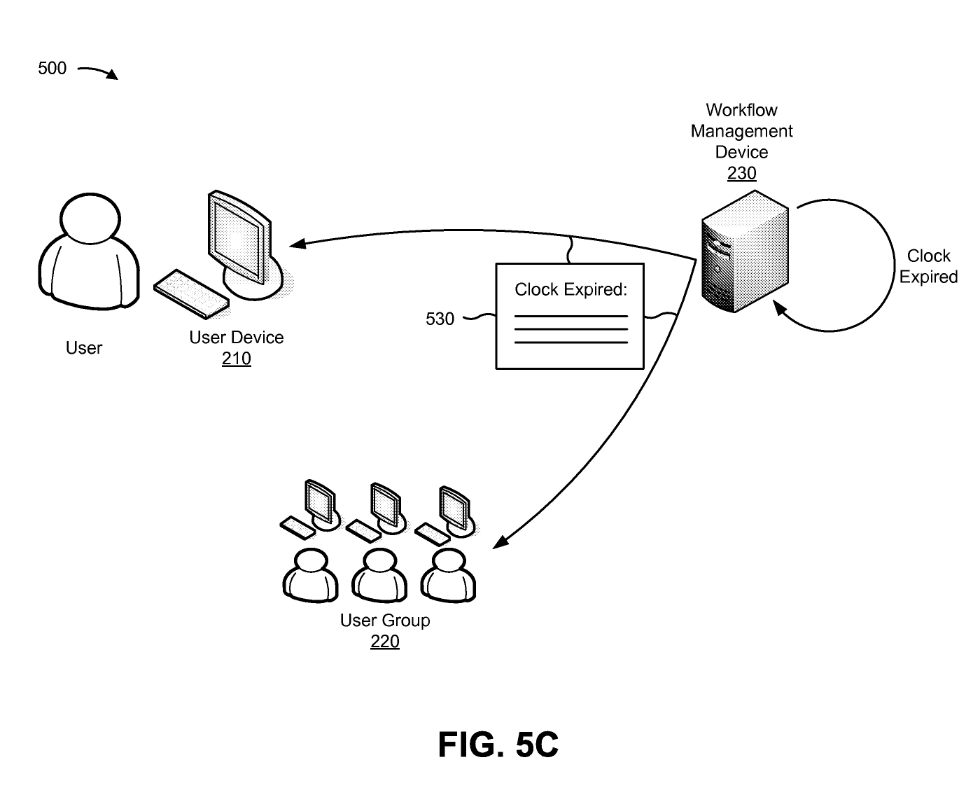

FIGS. 5A-5C are diagrams of an example implementation 500 relating to example process 400, shown in FIG. 4. FIG. 5A shows an example implementation where a user submits an incomplete license application, and is notified of the incomplete status of the application. FIG. 5B shows an example implementation where the user corrects the application. FIG. 5C shows an example implementation where the user does not correct the application, and a clock associated with the workflow step expires.

As shown in FIG. 5A, a user may submit, via user device 210, an incomplete application to license the use of field equipment 240 from a telecommunications company. Workflow management device 230 may receive the incomplete application, and may determine that the application is incomplete. For example, workflow management device 230 may access a data structure that stores information that identifies elements required for a complete application. Workflow management device 230 may determine, based on accessing the data structure, information that is missing from the license application.

Based on the received information, the missing information, and/or the workflow step, workflow management device 230 may generate a template notification, as shown by reference number 510. For example, template notification 510 may include information that identifies an issue with the received license application (e.g., that the application is incomplete), information that is missing from the received license application (e.g., an identification of the type of field equipment 240 requested for use), a time period for correcting the issue (e.g., five days), a user group 220 responsible for correcting the issue (e.g., the submitting user), etc. Workflow management device 230 may send template notification 510 to user group 220 responsible for correcting the incomplete application. In this example, user group 220 may include the user that submitted the application.

As shown in FIG. 5B, the user may correct the license application, and may submit, via user device 210, the corrected application to workflow management device 230. Workflow management device 230 may receive the corrected application, and may determine that the application is complete. Based on determining that the application is complete, workflow management device 230 may determine a next workflow step (e.g., that follows the workflow step of receiving a completed application), and may generate a template notification associated with a next workflow step, as shown by reference number 520. For example, template notification 520 may include information that identifies the next workflow step (e.g., make a payment associated with the license application), a time period for completing the next workflow step (e.g., ten days), a user group 220 responsible for completing the next workflow step (e.g., the submitting user), etc. Workflow management device 230 may send template notification 520 to user group 220 responsible for completing the next workflow step (e.g., making the application payment).

As shown in FIG. 5C, the user may fail to correct the application within a particular time period (e.g., based on FCC and/or licensor regulations or procedures). Workflow management device 230 may determine that the time period for correcting the application has expired (e.g., based on receiving an indication that a clock has expired), and may generate a template notification associated with the expiration of the time period, as shown by reference number 530. For example, template notification 530 may include information that identifies the workflow step associated with the clock expiration (e.g., correction of the license application), a user group 220 that receives the template notification, an indication that the time period associated with the workflow step has expired, etc.

In some implementations, template notification 530 may indicate that the license application has been cancelled. Alternatively, template notification 530 may indicate an amount of time remaining to complete the workflow step (e.g., to correct the application). Workflow management device 230 may send template notification 530 to user group 220 responsible for being notified of the clock expiration and/or responsible for completing the workflow step (e.g., correcting the application). In some implementations, user group 220 may include users associated with the licensee, the licensor, and/or FCC, who may be notified, for example, that the license application has been cancelled.

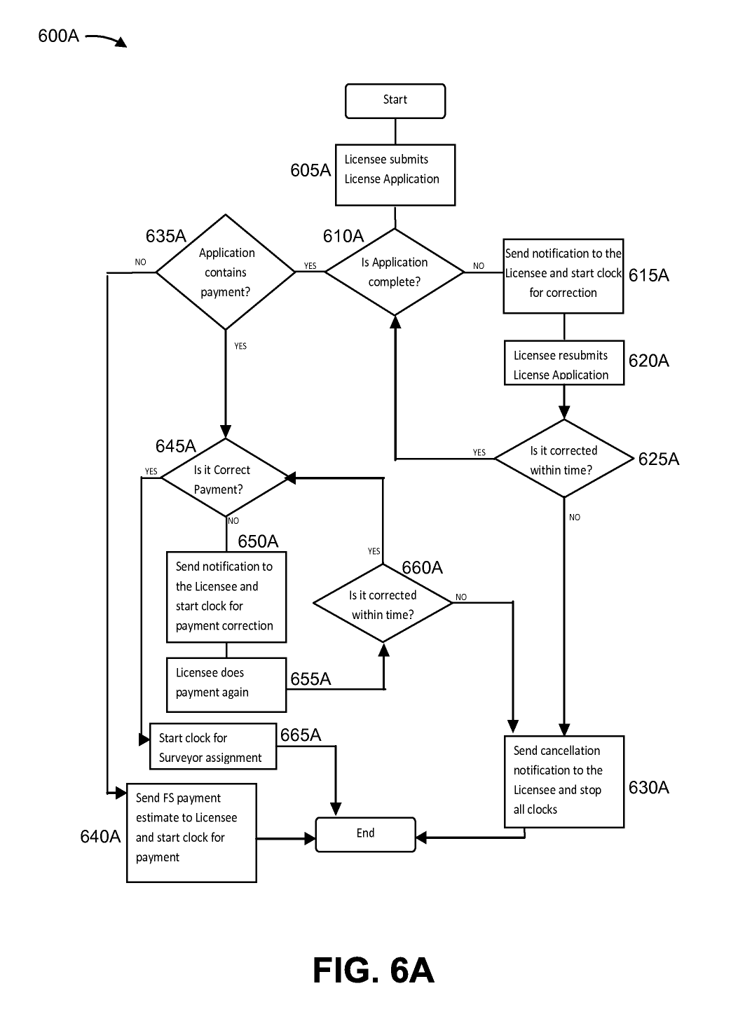

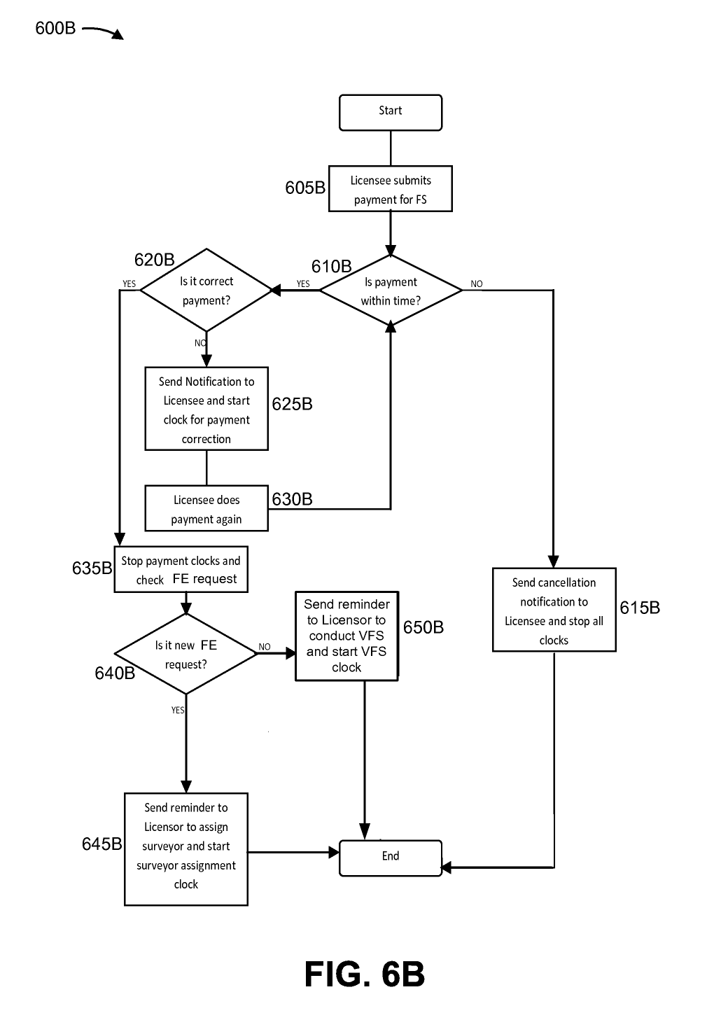

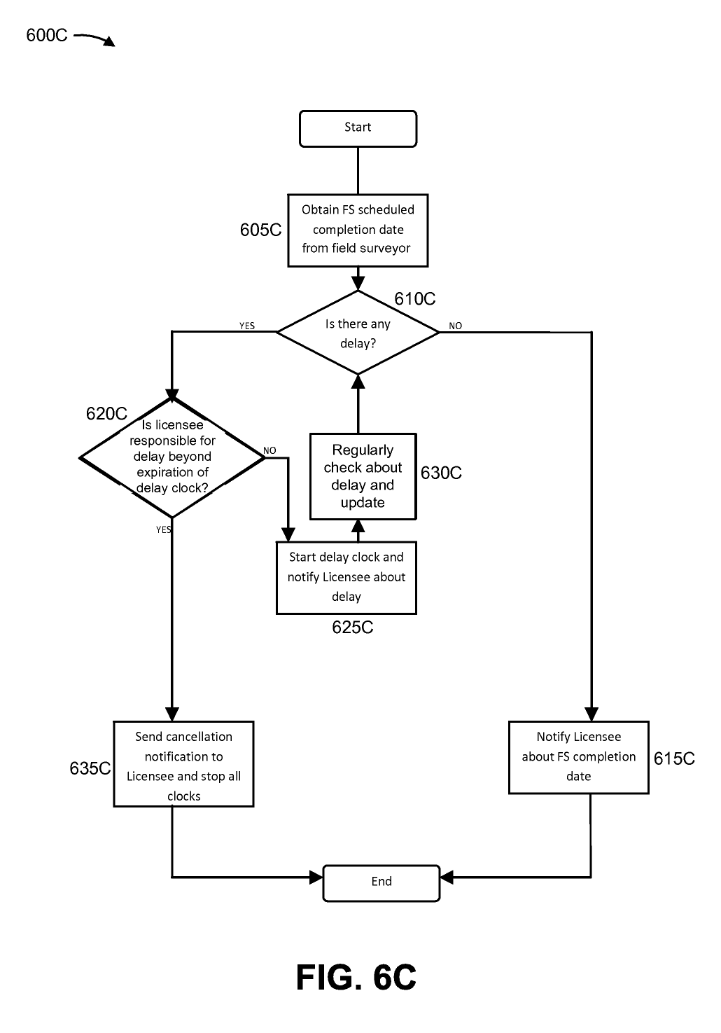

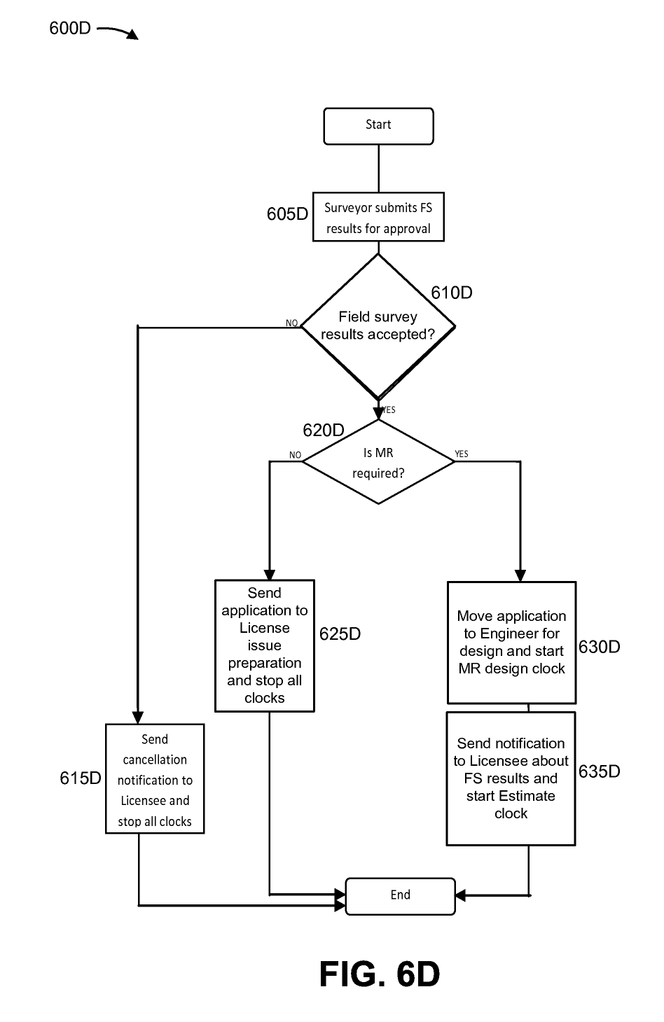

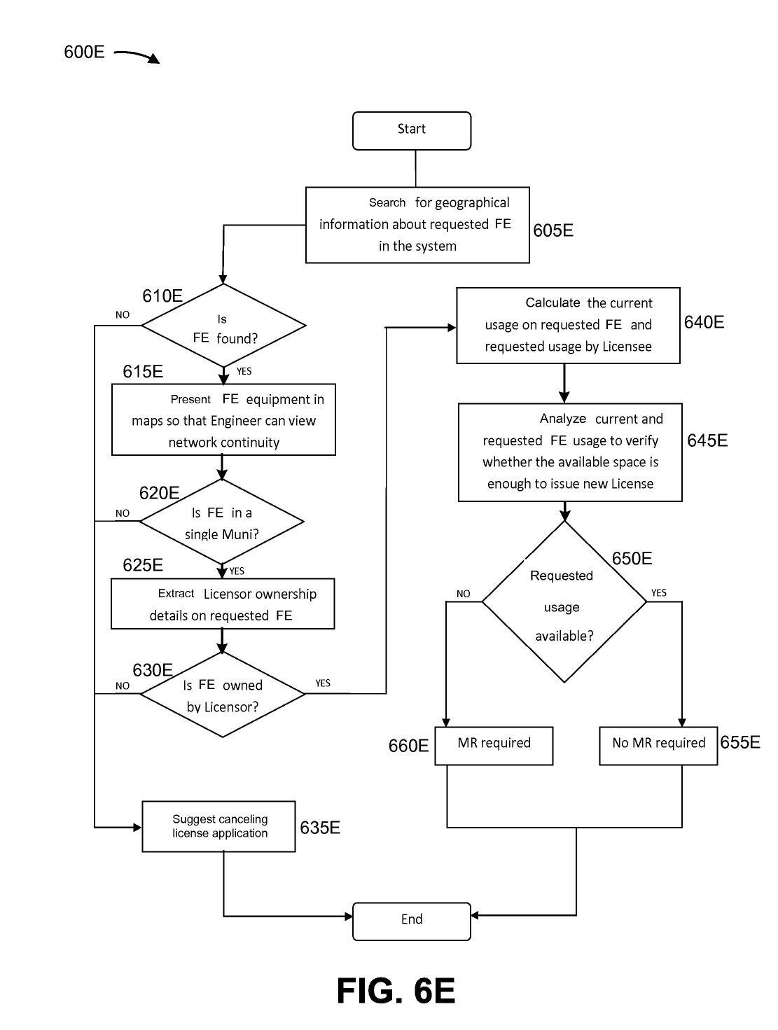

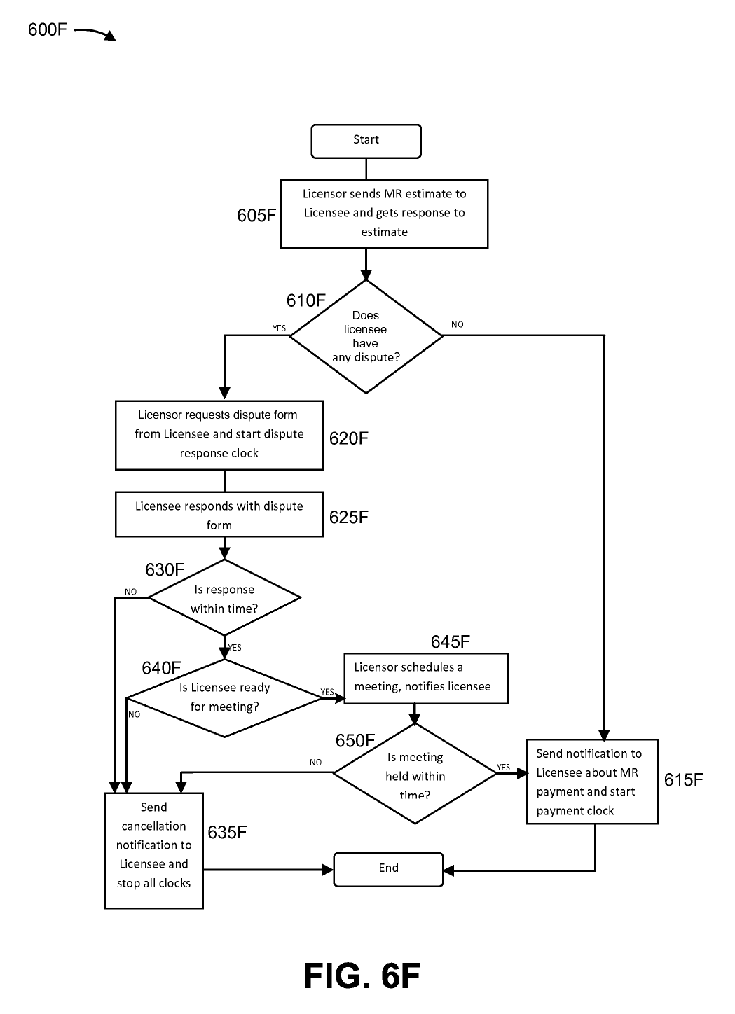

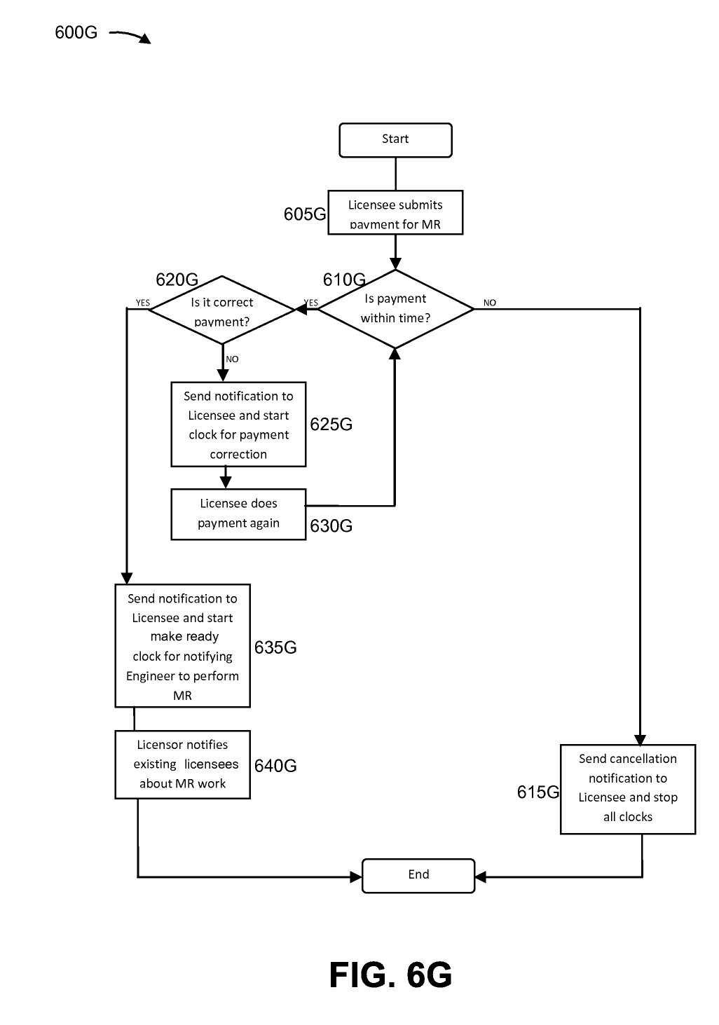

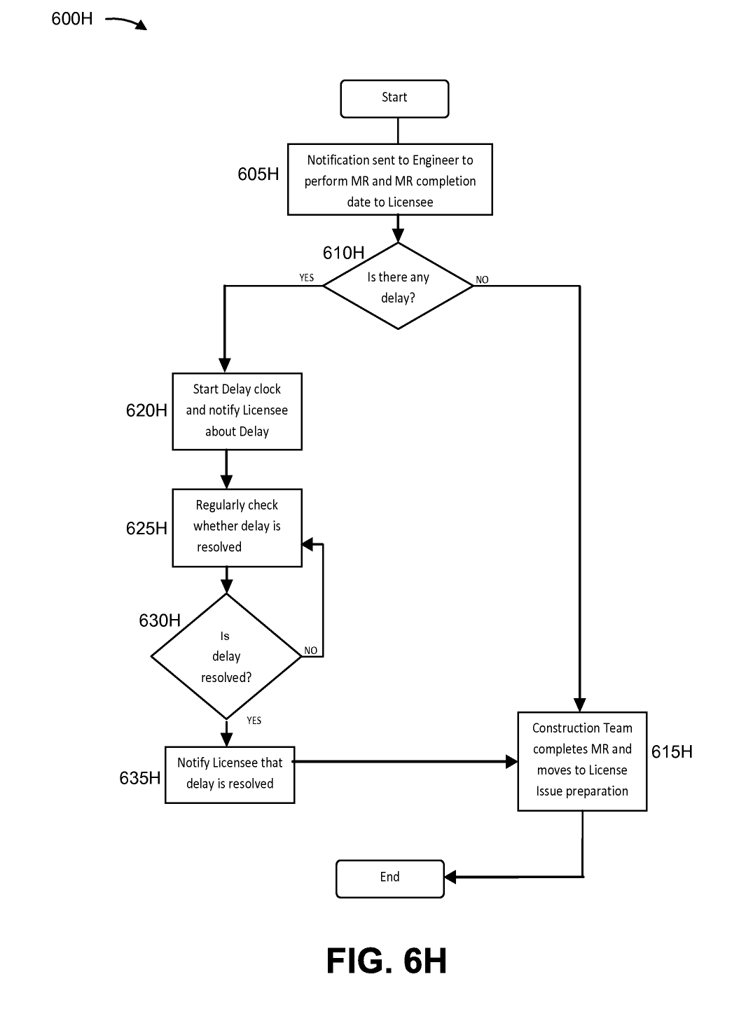

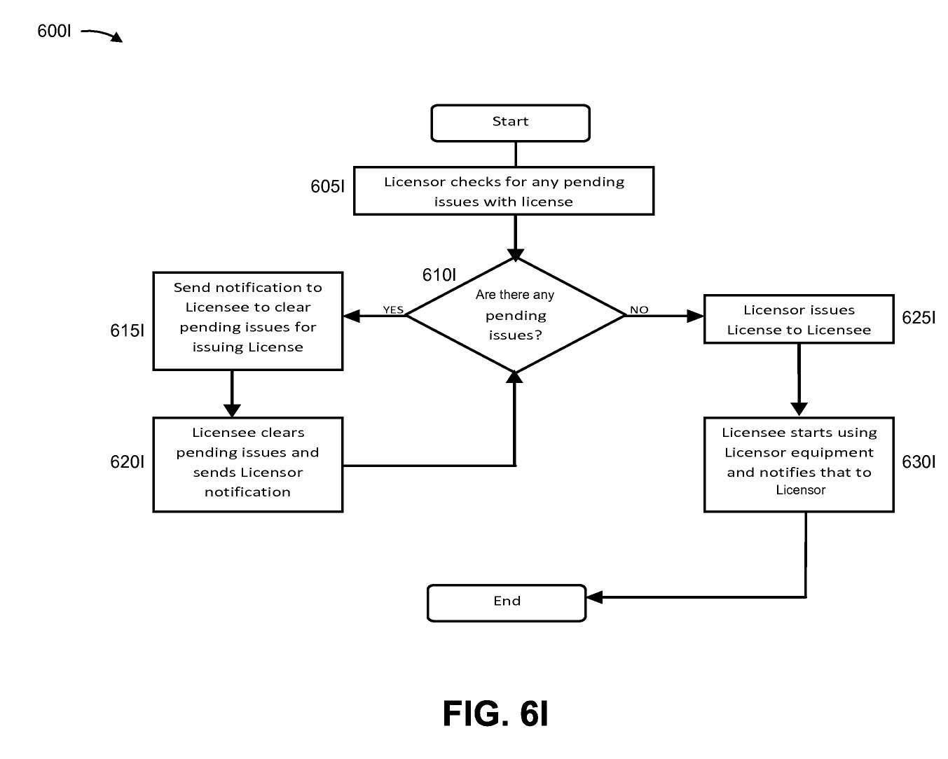

FIGS. 6A-6I are flow charts of example workflow steps 600A-600I that may be managed according to the example process shown in FIG. 4. One or more workflow steps and/or sub-steps shown in FIGS. 6A-6I may be managed according to the example process described in connection with FIG. 4. For example, one or more workflow steps and/or sub-steps shown in FIGS. 6A-6I may be associated with a clock and/or a template notification, as described in connection with FIG. 4. In some implementations, one or more workflow steps of FIGS. 6A-6I may be performed by workflow management device 230. Additionally, or alternatively, one or more workflow steps of FIGS. 6A-6I may be performed by another device or a group of devices separate from or including workflow management device 230, such as user device 210 and/or equipment management device 250.

FIG. 6A shows example workflow steps 600A for reviewing an application for a license to use field equipment 240 owned by a licensor telecommunications company.

As shown in FIG. 6A, workflow steps 600A may include licensee submission, via user device 210, of a license application to workflow management device 230 (block 605A). In some implementations, submission of the license application and/or receipt of the license application may cause workflow management device 230 to start a clock associated with license application review.

As further shown in FIG. 6A, workflow management device 230 may determine whether the application is complete (block 610A). If the application is not complete (block 610A—NO), then workflow management device 230 may send a template notification to the licensee, and may start a correction clock (block 615A). The licensee may resubmit, via user device 210, the license application (e.g., a corrected application) (block 620A), and workflow management device 230 may determine whether the resubmitted application is corrected and/or resubmitted within a time period tracked by the correction clock (block 625A).

If the application is not corrected and/or resubmitted in time (block 625A—NO), then workflow management device 230 may send a cancellation notification (e.g., a template notification that indicates that the license application process has been cancelled) to the licensee, and may stop all clocks associated with the license application (block 630A). If the application is corrected and/or resubmitted in time (block 625A—YES), then workflow management device 230 may return to block 610A to determine whether the application is complete (block 610A).

If the application is complete (block 610A—YES), then workflow management device 230 may determine whether the application includes a payment associated with the application process (block 635A). If the application does not include a payment (block 635A—NO), then workflow management device 230 may send a payment estimate (e.g., a payment estimate for a field survey) to the licensee, and may start the clock for receiving the payment (block 640A). In some implementations, workflow management device 230 may receive an estimate input from a user, and/or may calculate an estimate based on a workflow step, a user submitting the license application, requested field equipment 240, historical information, etc. If the application includes a payment (block 635A—YES), then workflow management device 230 may determine whether the included payment is for the correct amount (block 645A).

If the payment is not for the correct amount (block 645A—NO), then workflow management device 230 may send a template notification to the licensee, and may start a clock associated with receiving the correct payment (block 650A). The licensee may resubmit, via user device 210, the payment (e.g., a corrected payment) (block 655A), and workflow management device 230 may determine whether the payment is corrected and/or resubmitted within a time period tracked by the clock (block 660A).

If the payment is not corrected and/or resubmitted in time (block 660A—NO), then workflow management device 230 may send a cancellation notification to the licensee, and may stop all clocks associated with the license application (block 630A). If the payment is corrected and/or resubmitted in time (block 660A—YES), then workflow management device 230 may return to block 645A to determine whether the payment is correct (block 645A). In some implementations, the licensee may only be given one opportunity (or some other quantity of opportunities) to make corrections (e.g., to a payment, to an application, to submitted information, etc.). If the licensee fails to make the correction within a particular number of opportunities, workflow management device 230 may send a cancellation notification to the licensee, and may stop all clocks associated with the license application.

If the payment is for the correct amount (block 645A—YES), then workflow management device 230 may start a clock for assigning a field surveyor to perform a field survey of field equipment 240 requested in the application (block 665A).

FIG. 6B shows example workflow steps 600B for processing a field survey payment and determining whether to conduct a physical field survey or a virtual field survey. In some implementations, workflow steps 600B may begin after and/or concurrently with, for example, workflow step 635A, 640A, 645A, and/or 665A.

As shown in FIG. 6B, workflow steps 600B may include licensee submission, via user device 210, of a payment for a field survey (FS) to workflow management device 230 (block 605B). Workflow management device 230 may determine whether the payment was received in time (block 610B).

If the payment is not received in time (block 610B—NO), then workflow management device 230 may send a cancellation notification to the licensee, and may stop all clocks associated with the license application (block 615B). If the payment is received in time (block 610B—YES), then workflow management device 230 may determine whether the payment is for the correct amount (block 620B).

If the payment is not for the correct amount (block 620B—NO), then workflow management device 230 may send a template notification to the licensee, and may start a clock associated with receiving the correct payment (block 625B). The licensee may resubmit, via user device 210, the payment (e.g., a corrected payment) (block 630B), and workflow management device 230 may return to block 610B to determine whether the payment is corrected and/or resubmitted in time (block 610B).

If the payment is for the correct amount (block 620B—YES), then workflow management device 230 may stop a clock associated with making the payment (block 635B), and may determine whether the application requests a license for new field equipment (FE) or existing field equipment (block 640B).

If the application requests new field equipment (block 640B—YES), then workflow management device 230 may send a template notification to the licensor (e.g., user group 220) to assign a field surveyor to perform a physical field survey, and may start a clock associated with assigning a field surveyor (block 645B). If the application does not request new field equipment (e.g., requests existing equipment) (block 640B—NO), then workflow management device 230 may send a reminder to the licensor to conduct a virtual field survey (VFS), and may start a clock associated with conducting the virtual field survey (block 650B). A virtual field survey provides a means for the field surveyor to conduct a field survey without physically visiting the field equipment site.

FIG. 6C shows example workflow steps 600C for conducting a field survey (e.g., by an engineer and/or field surveyor). In some implementations, workflow steps 600C may begin after and/or concurrently with, for example, workflow step 640A, 665A, and/or 645B.

As shown in FIG. 6C, workflow steps 600C may include assigning a field surveyor (e.g., included in a user group 220) to conduct a field survey associated with the license application, and obtaining, from the assigned field surveyor, a field survey scheduled completion date (block 605C). The field survey may include a physical field survey, by the field surveyor, of a field equipment site. In some implementations, workflow management device 230 may generate an estimated completion date based on standards and rules used in field equipment licensing (e.g., FCC standards and rules), historical information (e.g., associated with past licenses, surveys, and/or construction), etc.

Workflow management device 230 may determine (e.g., by receiving input from the field surveyor) whether there is any delay to the scheduled completion date (block 610C). If there is no delay (block 610C—NO), then workflow management device 230 may notify the licensee about the field survey schedule completion date, and may start a clock associated with submitting the field survey results (block 615C). If there is a delay (block 610C—YES), then workflow management device 230 may determine whether the licensee is responsible for the delay beyond the expiration of a delay clock (block 620C). In some implementations, determining whether the licensee is responsible for the delay may include determining whether any party other than licensor is responsible for the delay (e.g., an electric company). Additionally, or alternatively, based on determining that there is a delay, workflow management device 230 may pause all clocks (e.g., other than a clock that tracks the delay) until the delay is resolved.

If the licensee is not responsible for the delay, or the delay clock has not expired (block 620C—NO), then workflow management device 230 may start (or continue) the delay clock, and may notify the licensee about the delay (block 625C). Workflow management device 230 may regularly check on the delay (e.g., by sending a request for delay information to user group 220 associated with the delay), may update delay information (block 630C), and may return to block 610C to determine whether there are any further delays. If the licensee is responsible for the delay, and/or the delay clock has expired (block 620C—YES), then workflow management device 230 may send a cancellation notification to the licensee, and may stop all clocks (block 635C).

FIG. 6D shows example workflow steps 600D for receiving field survey results and determining whether a make ready (MR) process is required for the license application. In some implementations, workflow steps 600D may begin after and/or concurrently with, for example, workflow step 645B, 650B, and/or 615C.

As shown in FIG. 6D, workflow steps 600D may include submitting, by a field surveyor (e.g., included in user group 220) the field survey results to workflow management device 230 (block 605D). Workflow management device 230 may determine whether the field survey results are accepted (e.g., by receiving input from a user group 220 and/or by analyzing the field survey results to determine whether the license may be granted) (block 610D).

If the field survey results are not accepted (block 610D—NO), then workflow management device 230 may send a cancellation notification to the licensee and may stop all clocks (block 615D). For example, the results may not be accepted if field equipment 240 is not owned by the licensor, does not have the capacity and/or space requested in the license application, and/or is otherwise unavailable for licensing. If the field survey results are accepted (block 610D—YES), then workflow management device 230 may determine whether a make ready process is required (block 620D). A make ready process may include provisioning field equipment 240, performing construction on field equipment 240, and/or otherwise installing or modifying field equipment 240 to perform the use requested in the license application.

If a make ready process is not required (block 620D—NO), then workflow management device 230 may send a template notification and/or the application to a user group 220 associated with a license issue preparation process (FIG. 6I), and may stop all clocks (block 625D). If a make ready process is required (block 620D—YES), then workflow management device 230 may send a template notification and/or the application to an engineer (e.g., associated with a user group 220) to design the make ready requirement, and may start a make ready design clock (block 630D). Once the engineer has completed and submitted the make ready design and a make ready estimate, workflow management device 230 may stop the make ready design clock, may send a notification to the licensee about the field survey results, and may start a clock associated with a make ready estimate (block 635D).

FIG. 6E shows example workflow steps 600E for conducting a virtual field survey (VFS) and determining whether a make ready (MR) process is required for the license application. In some implementations, workflow steps 600E may begin after and/or concurrently with, for example, workflow step 645B, 650B, and/or 615C. In some implementations, workflow steps 600E may be performed as an alternative to workflow steps 600C and/or 600D.

As shown in FIG. 6E, workflow steps 600E may include searching, by workflow management device 230, a system and/or a data structure for geographical information associated with the requested field equipment 240 (block 605E). For example, workflow management device 230 may determine, based on the received information associated with a license application, requested field equipment 240, and may search (e.g., by accessing a data structure and/or receiving information from another device, such as equipment management device 250) for geographical information associated with the requested field equipment 240.

Workflow management device 230 may determine whether the requested field equipment 240 was found via the search (block 610E). For example, workflow management device 230 may validate the existence of the requested field equipment 240. If the requested field equipment 240 is not found via the search (block 610E—NO), then workflow management device 230 may suggest (e.g., via a template notification) cancelling the license application (block 635E). Alternatively, workflow management device 230 may suggest performing a physical field survey associated with construction of new field equipment 240. If the requested field equipment 240 is found via the search (block 610E—YES), then workflow management device 230 may provide a representation of the requested field equipment 240 on a map (e.g., displayed on a display of user device 210 associated with a user included in user group 220 and/or workflow management device 230), so that a user can conduct a virtual field survey. For example, the user may use the map to determine a network continuity of the requested field equipment 240. In some implementations, the user may provide input to approve or deny the license application based on the virtual field survey.

Workflow management device 230 may determine whether the requested field equipment 240 is in a single municipality (block 620E). If the requested field equipment 240 is not in a single municipality (block 620E—NO), then workflow management device 230 may suggest (e.g., via a template notification) cancelling the license application due to difficulties in licensing the requested field equipment 240 across multiple municipalities (block 635E). If the requested field equipment 240 is in a single municipality (block 620E—YES), then workflow management device 230 may determine licensor ownership information associated with the requested field equipment 240 (block 625E). Workflow management device 230 may determine whether the requested field equipment 240 is owned by the licensor (block 630E).

If the requested field equipment 240 is not owned by the licensor (block 630E—NO), then workflow management device 230 may suggest (e.g., via a template notification) cancelling the license application (block 635E). If the requested field equipment 240 is owned by the licensor (block 630E—YES), then workflow management device 230 may calculate a current usage of the requested field equipment 240, and a requested usage by the licensee (block 640E). For example, workflow management device 230 may receive current usage information from field equipment 240 and/or equipment management device 250, and may receive requested usage information associated with the license application (e.g., received via user device 210).

Workflow management device 230 may analyze the current usage information and the requested usage information to determine whether the available usage satisfies the requested usage (blocks 645E and 650E). For example, workflow management device 230 may determine whether the requested usage is available by determining an available usage of field equipment 240 (e.g., by comparing and/or determining a difference between a current usage and a maximum and/or target usage).

If the requested usage is available (block 650E—YES), then workflow management device 230 may notify the appropriate user group 220 that a make ready process is not required (block 655E). If the requested usage is not available (block 650E—NO), the workflow management device 230 may notify the appropriate user group 220 that a make ready process is required (block 660E). The make ready process may include constructing and/or modifying field equipment 240 to support the requested usage.

FIG. 6F shows example workflow steps 600F for creating and approving a make ready estimate (e.g., an estimated payment required to make field equipment 240 ready for the use requested in the license application). In some implementations, workflow steps 600F may begin after and/or concurrently with, for example, workflow step 650B, 620D, 630D, 635D, and/or 660E.

As shown in FIG. 6F, workflow steps 600F may include sending, by the licensor (e.g., via workflow management device 230), a make ready estimate to the licensee (e.g., via user device 210), and receiving, by the licensor and from the licensee, a response to the make ready estimate (block 605F). In some implementations, workflow management device 230 may generate an estimate based on standards and rules used in field equipment licensing (e.g., FCC standards and rules), historical information (e.g., associated with past licenses, surveys, and/or construction), material requirements, etc.

Workflow management device 230 may determine, based on the response to the make ready estimate, whether the licensee has a dispute with the make ready estimate (block 610F). If the licensee does not have a dispute with the make ready estimate (block 610E—NO), then workflow management device 230 may send a template notification to the licensee regarding a make ready payment, may stop a make ready estimate clock, and may start a make ready payment clock (block 615F). If the licensee has a dispute with the make ready estimate (block 610E—YES), then workflow management device 230 may request a dispute form from the licensee, and may start a dispute response clock (block 620F). Additionally, or alternatively, based on determining that the licensee has a dispute, workflow management device 230 may pause all clocks (e.g., other than a clock that tracks a time period associated with the dispute) until the dispute is resolved. The licensee may respond to the request by sending the dispute form to workflow management device 230 (block 625F). Workflow management device 230 may determine whether the dispute form response is received in time (block 630F).

If the dispute form response is not received in time (block 630E—NO), then workflow management device 230 may send a cancellation notification to the licensee and may stop all clocks (block 635F). If the dispute form response is received in time (block 630F—YES), then workflow management device 230 may determine whether the licensee is ready for a meeting to discuss the dispute (block 640F). For example, workflow management device 230 may receive information identifying whether the licensee is ready to schedule and/or has scheduled a dispute resolution meeting.

If the licensee is not ready for a meeting to discuss the dispute (block 640E—NO), then workflow management device 230 may send a cancellation notification to the licensee and may stop all clocks (block 635F). If the licensee is ready for a meeting to discuss the dispute (block 640E—YES), then workflow management device 230 may schedule the meeting, and may notify the licensee of the scheduled meeting (block 645F). Workflow management device 230 may determine (e.g., via user input) whether the meeting is held in time (block 650F).

If the meeting is not held in time or the dispute is not resolved (block 650E—NO), then workflow management device 230 may send a cancellation notification to the licensee and may stop all clocks (block 635F). If the meeting is held in time and the dispute is resolved (block 650E—YES), then workflow management device 230 may send a notification (e.g., a template notification) to the licensee regarding a make ready payment, may stop a make ready estimate clock, and may start a make ready payment clock (block 615F). In some implementations, the make ready payment clock may be reset to an original duration. In some implementations, the parties may agree to a new estimate, and workflow management device 230 may start a new make ready estimate clock.

FIG. 6G shows example workflow steps 600G for receiving a payment associated with a make ready process. In some implementations, workflow steps 600G may begin after and/or concurrently with, for example, workflow step 620D, 630D, 635D, 660E, and/or 615F.

As shown in FIG. 6G, workflow steps 600G may include submitting, by the licensee (e.g., via user device 210), a payment associated with the make ready process (block 605G). Workflow management device 230 may determine whether the make ready payment is received in time (block 610G).

If the payment is not received in time (block 610G—NO), then workflow management device 230 may send a cancellation notification to the licensee, and may stop all clocks associated with the license application (block 615G). If the payment is received in time (block 610G—YES), then workflow management device 230 may determine whether the payment is for the correct amount (block 620G).

If the payment is not for the correct amount (block 620G—NO), then workflow management device 230 may send a template notification to the licensee, and may start a clock associated with receiving the correct payment (block 625G). The licensee may resubmit, via user device 210, the payment (e.g., a corrected payment) (block 630G), and workflow management device 230 may return to block 610G to determine whether the payment is corrected and/or resubmitted in time (block 610G).

If the payment is for the correct amount (block 620G—YES), then workflow management device 230 may send a template notification to the licensee and may start a make ready clock associated with notifying an engineer to perform the make ready process (block 635G). Additionally, or alternatively, workflow management device 230 may notify existing licensees of field equipment 240, associated with the make ready process, of the make ready work that is to be performed on field equipment 240 (block 640G).

FIG. 6H shows example workflow steps 600H for conducting a make ready process. The make ready process may include provisioning field equipment 240, performing construction on field equipment 240, and/or otherwise installing or modifying field equipment 240 to perform the use requested in the license application. In some implementations, workflow steps 600H may begin after and/or concurrently with, for example, workflow step 615F and/or 640G.

As shown in FIG. 6H, workflow steps 600H may include sending, by workflow management device 230 and to an engineer (e.g., included in user group 220), a notification to perform the make ready work, and sending, to the licensee, an estimated completion date for the make ready work (block 605H). Workflow management device 230 may determine (e.g., by receiving user input, such as from a construction team user group 220) whether there is any delay to the scheduled make ready completion date (block 610H).

If there is no delay (block 610H—NO), then workflow management device 230 may determine whether the make ready process has been completed, and may submit the license application to a user group 220 associated with preparing the license for issue (block 615H). If there is a delay (block 610H—YES), then workflow management device 230 may notify the licensee of the delay, and may start a delay clock (block 620H). Additionally, or alternatively, based on determining that there is a delay, workflow management device 230 may pause all clocks (e.g., other than a clock that tracks the delay) until the delay is resolved. Workflow management device 230 may regularly check on the delay (e.g., by sending a request for delay information to user group 220 associated with the delay) (block 625H), and may determine whether the delay has been resolved (block 630H).

If the delay has not been resolved (block 630H—NO), then workflow management device 230 may continue to check on the delay until the delay clock expires (block 625H). If the delay has been resolved (block 630H—YES), then workflow management device 230 may notify the licensee that the delay is resolved (block 635H), may determine that the make ready process has been completed, and may submit the license application to a user group 220 associated with preparing the license for issue (block 615H).

FIG. 6I shows example workflow steps 600I for issuing a license for the use of field equipment 240. In some implementations, workflow steps 600I may begin after and/or concurrently with, for example, workflow step 625D, 655E, and/or 615H.

As shown in FIG. 6I, workflow steps 600I may include checking, by workflow management device 230, the license to determine whether there are any pending issues with the license (blocks 605I and 610I).

If there are pending issues with the license (block 610I—YES), then workflow management device 230 may send a template notification to the licensee to clear all pending issues (block 615I), and may receive a notification that the licensee has cleared all pending issues with the license (block 620I). For example, a pending issue may include an outstanding bill, a compliance issue, etc.

If there are no pending issues with the license (block 610I—NO), then workflow management device 230 may issue the license, for the requested use of field equipment 240, to the licensee (block 625I). The licensee may start using field equipment 240, and workflow management device 230 may receive a notification (e.g., from the licensee, from field equipment 240, from equipment management device 250, etc.) that the licensee has started using field equipment 240 (block 630I).

While series of blocks have been described with regard to FIGS. 6A-6I, the blocks and/or the order of the blocks may be modified in some implementations. Additionally, or alternatively, non-dependent blocks may be performed in parallel.

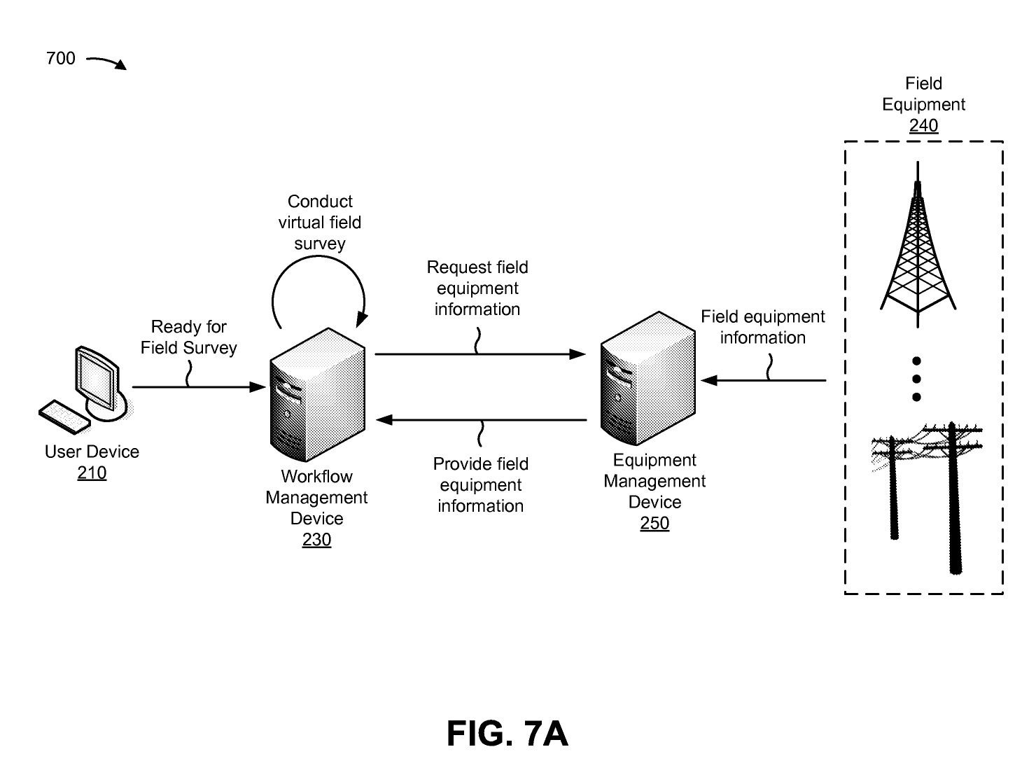

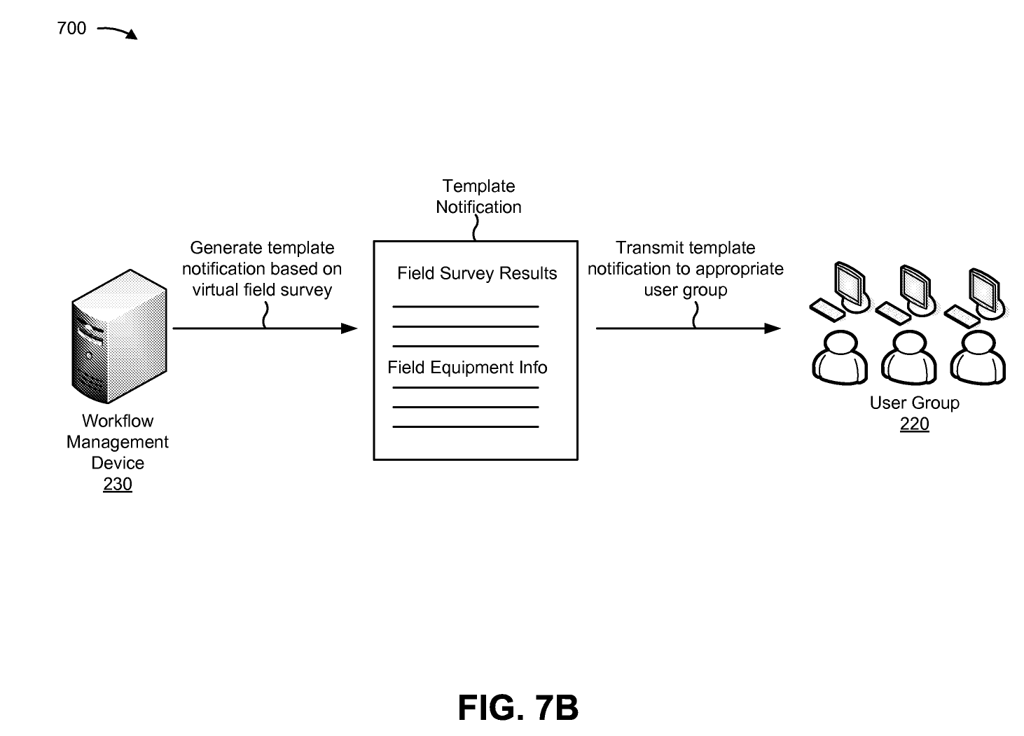

FIGS. 7A and 7B are diagrams of an example implementation 700 relating to example process 400, shown in FIG. 4, and example workflow steps 600A-600I, shown in FIGS. 6A-6I.

As shown in FIG. 7A, workflow management device 230 may receive, from user device 210, an indication that a field survey is to be conducted on field equipment 240 requested for use in a license application. Workflow management device 230 may determine that a virtual field survey is to be conducted. For example, workflow management device 230 may determine that a virtual field survey is to be conducted based on determining that information associated with the requested field equipment 240 is accessible in a data structure. The information may be accessible, for example, from equipment management device 250 and/or from field equipment 240.

Workflow management device 230 may conduct the virtual field survey. For example, workflow management device 230 may request, from equipment management device 250, field equipment information. Equipment management device 250 may receive field equipment information, for example, from field equipment 240, from a user, from another device, etc., and may provide the requested field equipment information to workflow management device 230. In some implementations, workflow management device 230 may present information to a user, such as an image of field equipment 240 (e.g., a site image), a map that shows requested field equipment 240 and connectivity between requested field equipment 240, etc. Workflow management device 230 may receive input from the user, and may conduct the virtual field survey based on the received input.

In some implementations, workflow management device 230 may conduct the virtual field survey by determining whether there is enough available space and/or usage of field equipment 240 to satisfy the requested space and/or usage of field equipment 240. When conducting the virtual field survey, workflow management device 230 may consider an available and/or requested length of field equipment 240 (e.g., a length of a conduit and/or pipe), an available and/or requested height of field equipment 240 (e.g., a height of a pole), an available and/or requested amount of space for installing infrastructure (e.g., wires) on field equipment 240, a quantity of other licensees and/or parties using (or applying to use) field equipment 240, spatial information associated with field equipment 240, a geographic location of field equipment 240 (which may be used to generate a map that gives a pictorial representation of field equipment 240), a quantity of existing and/or available field equipment 240, current and/or past work done on field equipment 240 (e.g., construction work), existing licenses associated with field equipment 240, standards and rules using in field equipment licensing (e.g., FCC standards and rules), historical information associated with past field surveys, etc.

In some implementations, workflow management device 230 may receive information from other devices to conduct the virtual field survey. For example, workflow management device 230 may receive information from field equipment 240, equipment management device 250, third party devices, device associated with a municipality in which field equipment 240 is located, inventory systems that track field equipment 240, etc.

As shown in FIG. 7B, workflow management device 230 may generate a template notification based on the virtual field survey. The template notification may include, for example, results of the virtual field survey (e.g., whether the license application is approved or denied), field equipment information (e.g., received by workflow management device 230), a time for completing a next workflow step following the field survey, a user group 220 associated with the field survey, etc. Workflow management device 230 may transmit the template notification to an appropriate user group 220 (e.g., a user group 220 responsible for a workflow step following the field survey).

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term “component” is intended to be broadly construed as hardware, firmware, or a combination of hardware and software.

It will be apparent that systems and/or methods, as described herein, may be implemented in many different forms of software, firmware, and hardware in the implementations illustrated in the figures. The actual software code or specialized control hardware used to implement these systems and/or methods is not limiting of the implementations. Thus, the operation and behavior of the systems and/or methods were described without reference to the specific software code—it being understood that software and control hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Further, the phrase “based on” is intended to mean “based, at least in part, on” unless explicitly stated otherwise.

What is claimed is:

1. A device, comprising:
one or more processors to:
receive application information associated with an application for a license to use field equipment associated with a potential licensor, the application information identifying a potential licensee, the field equipment, and a requested usage of the field equipment;
determine, based on the application information and the identified field equipment, that a virtual field survey is to be conducted;
receive, based on determining that the virtual field survey is to be conducted, information that identifies an available usage of the field equipment;
conduct the virtual field survey by determining that the available usage satisfies the requested usage; and
transmit, based on determining that the available usage satisfies the requested usage, a notification to a licensee device associated with the potential licensee or a licensor device associated with the potential licensor.

2. The device of claim 1, where the field equipment includes at least one of:
a pole;
a man hole;
a conduit;
a pipe;
a cable;
a utility box;
a service drop;
a base station; or
an antenna.

3. The device of claim 1, where the one or more processors are further to:
determine a deadline associated with conducting the virtual field survey, the deadline being based on a time at which the application information is received;
receive an indication that the deadline has passed; and
transmit, based on receiving the indication that the deadline has passed, a cancellation notification to the licensee device or the licensor device.

4. The device of claim 1, where the one or more processors are further to:
determine that the potential licensor owns or has a right to license the field equipment; and
where the one or more processors, when transmitting the notification to the licensee device or the licensor device, are further to:
transmit, based on determining that the potential licensor owns or has a right to license the field equipment, the notification to the licensee device or the licensor device.

5. The device of claim 1, where the one or more processors, when determining that the virtual field survey is to be conducted, are further to:
receive information indicating that the field equipment exists; and
determine, based on receiving the information indicating that the field equipment exists, that the virtual field survey is to be conducted.

6. The device of claim 1, where the one or more processors, when receiving the information that identifies the available usage of the field equipment, are further to:
receive the information from the field equipment or a device associated with the field equipment.

7. The device of claim 1, where the one or more processors are further to:
provision the field equipment based on determining that the available usage satisfies the requested usage.

8. A computer-readable medium storing instructions, the instructions comprising:
one or more instructions that, when executed by a processor, cause the processor to:
receive application information associated with an application for a license to use field equipment associated with a potential licensor, the application information identifying a potential licensee, the field equipment, and a requested usage of the field equipment;
receive information that identifies an available usage of the field equipment;
determine that the available usage satisfies the requested usage; and
transmit, based on determining that the available usage satisfies the requested usage, a notification to a licensee device associated with the potential licensee or a licensor device associated with the potential licensor.

9. The computer-readable medium of claim 8, where the field equipment includes at least one of:
a pole;
a man hole;
a conduit;
a pipe;
a cable;
a utility box;
a service drop; or
a base station; or
an antenna.

10. The computer-readable medium of claim 8, where the one or more instructions further cause the processor to:
determine a deadline associated with transmitting the notification, the deadline being based on a time at which the application information is received;
receive an indication that the deadline has passed; and
transmit, based on receiving the indication that the deadline has passed, a cancellation notification to the licensee device or the licensor device.

11. The computer-readable medium of claim 8, where the one or more instructions further cause the processor to:
determine that the potential licensor owns or has a right to license the field equipment; and
where the one or more instructions, that cause the processor to transmit the notification to the licensee device or the licensor device, further cause the processor to:
transmit, based on determining that the potential licensor owns or has a right to license the field equipment, the notification to the licensee device or the licensor device.

12. The computer-readable medium of claim 8, where the available usage includes at least one of:
an available length of the field equipment;
an available height of the field equipment;
an available amount of space for installing infrastructure associated with the field equipment;
a quantity of licensees associated with the field equipment; or
a geographic location of the field equipment.

13. The computer-readable medium of claim 8, where the one or more instructions, that cause the processor to receive the information that identifies the available usage of the field equipment, further cause the processor to:
receive the information from the field equipment or a device associated with the field equipment.

14. The computer-readable medium of claim 8, where the one or more instructions further cause the processor to:
provision the field equipment based on determining that the available usage satisfies the requested usage.

15. A method, comprising:
receiving, by a device, application information associated with an application for a license to use field equipment associated with a potential licensor, the application information identifying a potential licensee, the field equipment, and a requested usage of the field equipment;
determining, by the device and based on the application information and the identified field equipment, that a virtual field survey is to be conducted;
receiving, by the device and based on determining that the virtual field survey is to be conducted, information that identifies an available usage of the field equipment;
conducting, by the device, the virtual field survey by determining that the available usage satisfies the requested usage; and
transmitting, by the device and based on determining that the available usage satisfies the requested usage, a notification to one or more user devices associated with processing the application.

16. The method of claim 15, where the field equipment includes at least one of:
a pole;
a man hole;
a conduit;
a pipe;
a cable;
a utility box;
a service drop; or
a base station; or
an antenna.

17. The method of claim 15, further comprising:
determining a deadline associated with conducting the virtual field survey, the deadline being based on a time at which the application information is received;
receiving an indication that the deadline has passed; and
transmitting, based on receiving the indication that the deadline has passed, a cancellation notification to the one or more user devices.

18. The method of claim 15, further comprising:
determining that the potential licensor owns or has a right to license the field equipment; and
where transmitting the notification to the one or more user devices further comprises:
transmitting, based on determining that the potential licensor owns or has a right to license the field equipment, the notification to the one or more user devices.

19. The method of claim 15, where determining that the virtual field survey is to be conducted further comprises:
receiving information indicating that the field equipment exists; and
determining, based on receiving the information indicating that the field equipment exists, that the virtual field survey is to be conducted.

20. The method of claim 15, where receiving the information that identifies the available usage of the field equipment further comprises:
receiving the information from the field equipment or a device associated with the field equipment.
